(19) United States
(12) Patent Application Publication
(10) Pub. No.: US 2025/0218317 A1
(43) Pub. Date: Jul. 3, 2025

(54) DISPLAY METHOD OF HEAD-UP DISPLAY AND HEAD-UP DISPLAY

(71) Applicants: Innolux Corporation, Miaoli County (TW); CARUX TECHNOLOGY PTE. LTD., SINGAPORE (SG)

(72) Inventors: Yi-Cheng Chang, Tainan (TW); Cheng-Wu Lin, Miaoli County (TW)

(73) Assignees: Innolux Corporation, Miaoli County (TW); CARUX TECHNOLOGY PTE. LTD., SINGAPORE (SG)

(21) Appl. No.: 18/963,554

(22) Filed: Nov. 28, 2024

Related U.S. Application Data
(60) Provisional application No. 63/614,921, filed on Dec. 27, 2023.

(30) Foreign Application Priority Data
Sep. 10, 2024 (CN) 202411264245.5

(51) Int. Cl. G09G 3/00; B60K 35/234; G06T 5/80

(52) U.S. Cl. CPC G09G 3/001; B60K 35/234; G06T 5/80; G09G 2320/0233; G09G 2320/0626; G09G 2320/0686

(57) ABSTRACT

Provided are a display method of a head-up display and a head-up display. The display method of the head-up display includes the following steps: an original image is received; an image boundary of the original image is corrected based on projection surface distortion data to generate a corrected image; multiple first sub-light-emitting regions corresponding to an image boundary of the corrected image are determined; light emitting data are adjusted based on display boundary data to increase brightness values corresponding to the multiple first sub-light-emitting regions in the light emitting data, and brightness values of multiple second sub-light-emitting regions corresponding to a non-display region in the light emitting data are set as 0; and a display module is driven based on the corrected image and an adjusted light emitting data. The display method of the head-up display and the head-up display of the disclosure may achieve good display effects.

### CROSS-REFERENCE TO RELATED APPLICATION

This application claims the priority benefit of U.S. provisional application Ser. No. 63/614,921, filed on Dec. 27, 2023 and China application serial no. 202411264245.5, filed on Sep. 10, 2024. The entirety of each of the above-mentioned patent applications is hereby incorporated by reference herein and made a part of this specification.

### BACKGROUND

### Technical Field

The disclosure relates to a display technology, and in particular to a display method of a head-up display and a head-up display.

### Description of Related Art

A conventional head-up display can simply project a display frame onto a projection surface (such as a windshield) to provide a projection frame for the driver to watch. However, since the projection surface may have a distorted or uneven surface, a display region of the projection frame might be deformed, and a non-display region of the projection image is also likely to have the problem of light leakage.

### SUMMARY

The disclosure is related to a display method of a head-up display and a head-up display that can achieve good display effects.

According to an embodiment of the disclosure, the display method of the head-up display of the disclosure includes the following steps: an original image is received; an image boundary of the original image is corrected based on projection surface distortion data to generate a corrected image; multiple first sub-light-emitting regions corresponding to an image boundary of the corrected image are determined; light emitting data is adjusted based on the image boundary of the corrected image to increase brightness values corresponding to the multiple first sub-light-emitting regions in the light emitting data, and brightness values corresponding to multiple second sub-light-emitting regions of a non-display region in the light emitting data are set as 0; and a display module is driven based on the corrected image and an adjusted light emitting data.

According to an embodiment of the disclosure, the head-up display of the disclosure includes a display module and a control module. The control module is coupled to the display module. The control module receives an original image and corrects an image boundary of the original image based on projection surface distortion data to generate a corrected image. The control module determines multiple first sub-light-emitting regions corresponding to an image boundary of the corrected image, and adjusts light emitting data based on display boundary data to increase brightness values corresponding to the multiple first sub-light-emitting regions in the light emitting data, and sets brightness values corresponding to multiple second sub-light-emitting regions of a non-display region in the light emitting data as 0. The control module drives the display module based on the corrected image and an adjusted light emission data.

Based on the above, the display method of the head-up display and the head-up display of the disclosure can effectively improve the problem of light leakage of the head-up display.

In order to make the foregoing content more comprehensible, the following embodiments are given and described in detail with the accompanying drawings as follows.

### BRIEF DESCRIPTION OF THE DRAWINGS

FIG. 1 is a schematic diagram of a head-up display according to an embodiment of the disclosure.

FIG. 2 is a flow chart of a display method of a head-up display according to an embodiment of the disclosure.

FIG. 3 is a schematic diagram of a head-up display according to an embodiment of the disclosure.

FIG. 4 is a schematic diagram of a head-up display according to another embodiment of the disclosure.

FIG. 5 is a schematic diagram of a corrected image according to an embodiment of the disclosure.

FIG. 6 is a driving diagram of a pixel array according to an embodiment of the disclosure.

FIG. 7 is a schematic diagram of a corrected image according to another embodiment of the disclosure.

FIG. 8 is a flow chart of a display method of a head-up display according to another embodiment of the disclosure.

### DESCRIPTION OF THE EMBODIMENTS

Reference will now be made in detail to the exemplary embodiments of the disclosure. Examples of the embodiments are illustrated in the accompanying drawings. Wherever possible, the same reference numerals are used in the drawings and the description to refer to the same or like elements.

Throughout the specification and the appended claims of the disclosure, certain terms are used to refer to specific elements. Those skilled in the art should understand that device manufacturers may probably use different names to refer to the same elements. This specification is not intended to distinguish between elements that have the same function but different names. In the following specification and claims, the terms “including,” “containing,” etc., are open-ended terms, so they should be interpreted to mean “including but not limited to . . . ”.

In some embodiments of the disclosure, terms such as “connect” and “interconnect” with respect to bonding and connection, unless specifically defined, may refer to two structures that are in direct contact (in indirect contact) with each other, or may refer to two structures that are indirectly in contact with each other, wherein there are other structures set between these two structures. In addition, the terms that describe joining and connecting may apply to the case where both structures are movable or both structures are fixed. In addition, the term “coupling” involves the transfer of energy between two structures by means of direct or indirect electrical connection, or the transfer of energy between two separate structures by means of mutual induction. Although terms such as “first,” “second,” etc. can be used to describe a variety of elements, the elements are not limited by this term. This term is only used to distinguish a single element from other elements in the specification. Different terminologies may be adopted in claims and the description, and replaced with the first, second, third . . . in accordance with the order of elements specified in the claims. Therefore, in the following description, the first element may be described as the second element in the claims. In the disclosure, the features of multiple embodiments to be described below may be replaced, recombined, or mixed to form other embodiments without departing from the spirit of the disclosure.

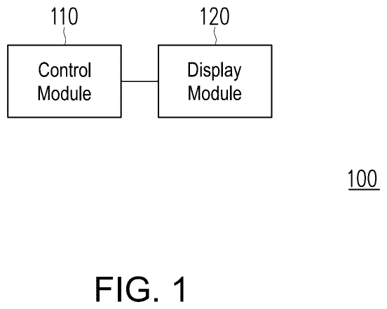

FIG. 1 is a schematic diagram of a head-up display according to an embodiment of the disclosure. Referring to FIG. 1, a head-up display (HUD) 100 includes a control module 110 and a display module 120. The control module 110 is coupled to the display module 120. In the embodiment, the control module 110 may include a controller, a storage device, and a communication interface. The display module 120 may include a panel and a communication interface. In the embodiment, the control module 110 may receive image data and correct the image data to drive the display module 120 to display corresponding image content based on the corrected image data. Furthermore, an image frame displayed by the display module 120 may be projected onto a projection surface (such as a windshield of a vehicle) to display a projection frame. Users may watch the projection frame reflected by the projection surface through the projection surface. The display module 120 may include a liquid crystal display, an OLED, a micro LED display, etc. In the embodiment, the liquid crystal display includes a backlight module. The backlight module has a light emitting region formed by multiple sub-light-emitting regions arranged in an array, and the multiple sub-light-emitting regions may respectively include one or multiple light emitting units (such as light emitting diode, LED). In the embodiment, the head-up display 100 may be a panoramic head-up display (PHUD). In other embodiments, the display module 120 may be a micro LED display that has a light emitting region formed by multiple sub-light-emitting regions arranged in an array, and the multiple sub-light-emitting regions may respectively include one or multiple pixels. There are light emitting units (such as light emitting diode, LED) in the pixels.

In the embodiment, the control module 110 may be, for example, a timing controller (TCON). In an embodiment, the controller may include, for example, a central processing unit (CPU), or other programmable general-purpose or special-purpose microprocessors, a digital signal processor (DSP), an image processing unit (IPU), a graphics processing unit (GPU), a programmable controller, application specific integrated circuits (ASIC), a programmable logic device (PLD), other similar processing devices, or a combination of these devices. In the embodiment, the storage device may include, for example, a dynamic random access memory (DRAM), a flash memory, or a non-volatile random access memory (NVRAM), etc. In the embodiment, the communication interface may, for example, include a data transmission interface and a driving interface. The data transmission interface may include a data receiving interface or a data sending interface.

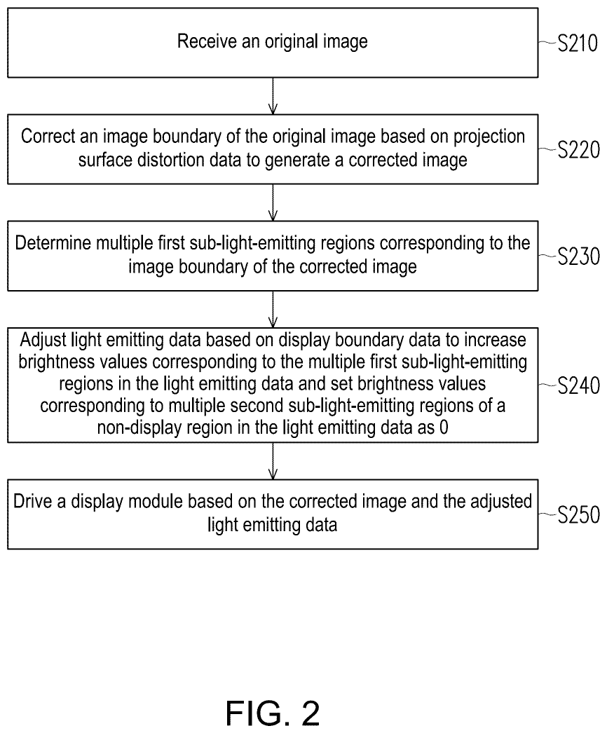

FIG. 2 is a flow chart of a display method of a head-up display according to an embodiment of the disclosure. Referring to FIG. 1 and FIG. 2, the head-up display 100 may perform the following steps S210 to S250. In step S210, the control module 110 may receive an original image. In step S220, the control module 110 may correct an image boundary of the original image based on projection surface distortion data to generate a corrected image. In the embodiment, the control module 110 may correct the image boundary of the original image based on a preset projection surface distortion data to allow a frame shape (boundary) of a projection frame displayed on a projection surface to form an appropriate non-distorted image, that is, users may see a rectangular projection frame from the projection surface (such as a windshield of a vehicle). In an embodiment, the head-up display 100 may also include a sensor, and may sense a projection surface distortion condition of the projection surface to generate corresponding projection surface distortion data.

In step S230, the control module 110 may determine multiple first sub-light-emitting regions corresponding to an image boundary of the corrected image. In step S240, the control module 110 may adjust light emitting data based on display boundary data to increase brightness values corresponding to the multiple first sub-light-emitting regions in the light emitting data, and set brightness values corresponding multiple second sub-light-emitting regions of a non-display region in the light emitting data as 0. In the embodiment, the control module 110 may increase the brightness of the pixels of the image boundary of the display region of the corrected image passing through the sub-light-emitting regions, and turn off the pixels of the non-display region outside the image boundary.

In step S250, the control module 110 may drive the display module 120 based on the corrected image and an adjusted light emitting data. In the embodiment, the display module 120 may include a display panel and a light emitting module. The control module 110 may drive the display panel to display corresponding image content based on the corrected image, and may drive the light emitting module based on the adjusted light emitting data to effectively reduce light leakage caused by light emitted from the non-display region illuminating onto the projection surface. In an embodiment, the display module 120 may also include a self-light-emitting display panel, and the control module 110 may drive the self-light-emitting display panel based on the corrected image and the adjusted light emitting data.

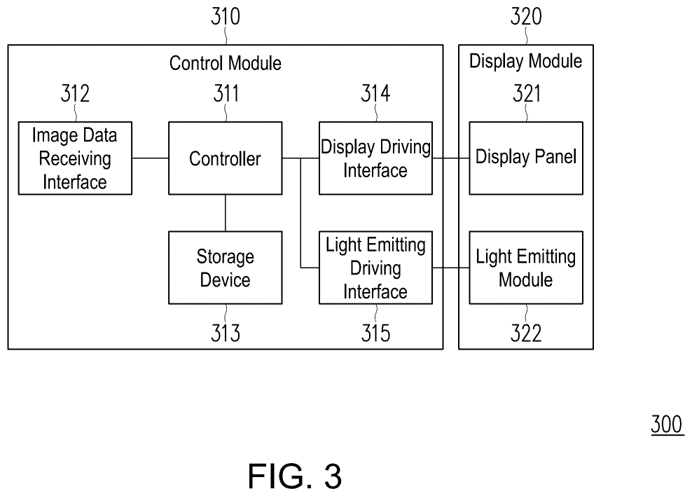

FIG. 3 is a schematic diagram of a head-up display according to an embodiment of the disclosure. Referring to FIG. 3, the head-up display of the disclosure may be implemented as a head-up display 300 as shown in FIG. 3. The head-up display 300 includes a control module 310 and a display module 320. The control module 310 includes a controller 311, an image data receiving interface 312, a storage device 313, a display driving interface 314, and a light emitting driving interface 315. The controller 311 is coupled to the image data receiving interface 312, the storage device 313, the display driving interface 314 and the light emitting driving interface 315. The display module 320 includes a display panel 321 and a light emitting module 322. The control module 310 may be coupled to the display panel 321 through the display driving interface 314. The control module 310 may be coupled to the light emitting module 322 through the light emitting driving interface 315. In the embodiment, the control module 310 may be a timing controller, and may implement functions of correcting image boundaries and adjusting light emitting brightness of sub-light-emitting regions.

In the embodiment, the controller 311 may obtain projection surface distortion data from the outside in advance. For example, the controller 311 may obtain projection surface distortion data from a flash IC. The controller 311 may store the projection surface distortion data in the storage device 313. When the head-up display 300 is to perform a display operation, the controller 311 may receive an original image provided by an image source through the image data receiving interface 312, and may read the projection surface distortion data from the storage device 313 to correct a shape of an image boundary of the original image based the projection surface distortion data and generate a corrected image. In other words, the shape of the image boundary of the original image may be different from a shape of an image boundary of the corrected image. Next, the controller 311 may determine multiple first sub-light-emitting regions of the light emitting module corresponding to the image boundary of the corrected image based on the corrected image to adjust an image boundary parameter in light emitting data based on the image boundary of the corrected image. The controller 311 may drive the display panel 321 through the display driving interface 314 based on the corrected image, and may drive the light emitting module 322 through the light emitting driving interface 315 based on an adjusted light emitting data.

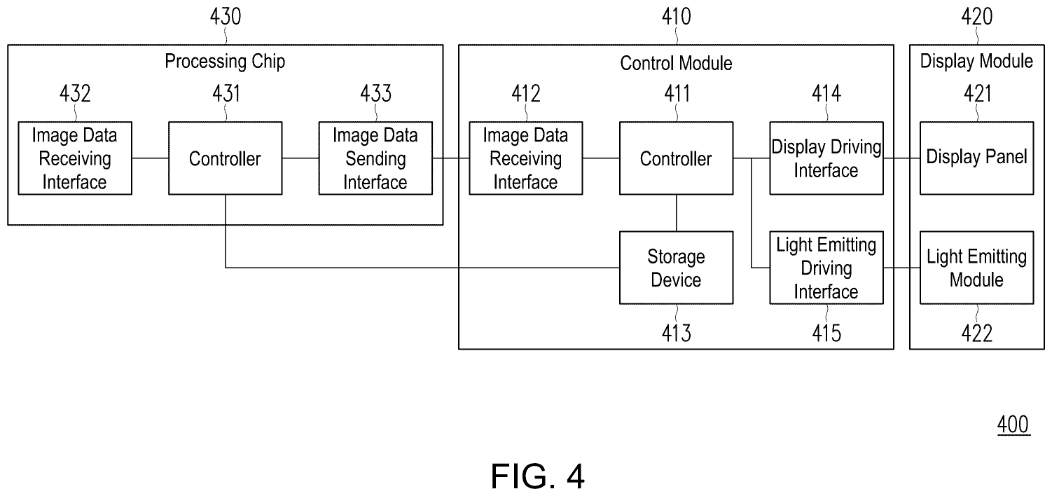

FIG. 4 is a schematic diagram of a head-up display according to another embodiment of the disclosure. Referring to FIG. 4, the head-up display of the disclosure may be implemented as a head-up display 400 shown in FIG. 4. The head-up display 400 includes a control module 410, a display module 420, and a processing chip 430. In the embodiment, the control module 410 includes a controller 411, an image data receiving interface 412, a storage device 413, a display driving interface 414, and a light emitting driving interface 415. The controller 411 is coupled to the image data receiving interface 412, the storage device 413, the display driving interface 414 and the light emitting driving interface 415. In the embodiment, the display module 420 includes a display panel 421 and a light emitting module 422. The control module 410 may be coupled to the display panel 421 through the display driving interface 414. The control module 410 may be coupled to the light emitting module 422 through the light emitting driving interface 415. In the embodiment, the processing chip 430 includes a controller 431, an image data receiving interface 432, and an image data sending interface 433. The controller 431 is coupled to the image data receiving interface 432 and the image data sending interface 433. The processing chip 430 is coupled to the image data receiving interface 412 of the control module 410 through the image data sending interface 433.

In the embodiment, the controller 431 may obtain projection surface distortion data from the outside in advance. For example, the controller 431 may obtain projection surface distortion data from a flash memory chip. The controller 431 may store the projection surface distortion data in the storage device 413. When the head-up display 400 is to perform a display operation, the controller 431 may receive an original image provided by an image source through the image data receiving interface 432, and may read the projection surface distortion data from the storage device 413 to correct a shape of an image boundary of the original image based on the projection surface distortion data and generate a corrected image. Next, the controller 431 may send the image data of the corrected image to the image data receiving interface 412 of the control module 410 through the image data sending interface 433. Next, the controller 411 may determine multiple first sub-light-emitting regions of the light emitting module corresponding to an image boundary of the corrected image based on the corrected image to adjust light emitting data based on the image boundary of the corrected image. The controller 411 may drive the display panel 421 through the display driving interface 414 based on the corrected image, and drive the light emitting module 422 through the light emitting driving interface 415 based on an adjusted light emitting data. In the embodiment, the control module 410 may be a timing controller, and the processing chip 430 may be a chip having an image data computing function. In the embodiment, the control module 410 may implement the function of adjusting light emitting brightness of sub-light-emitting regions, and the processing chip 430 may implement the function of correcting image boundaries.

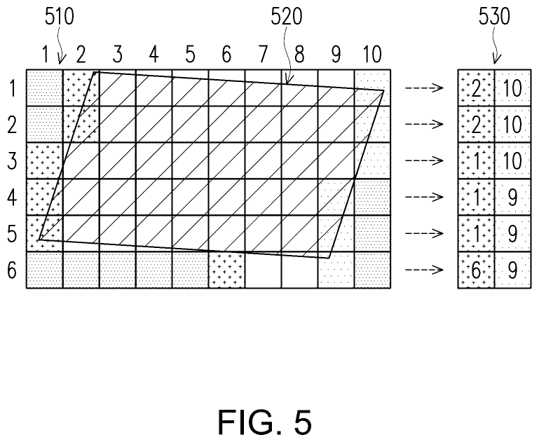

FIG. 5 is a schematic diagram of a corrected image according to an embodiment of the disclosure. Referring to FIG. 1 and FIG. 5, in the embodiment, a light emitting region 510 of a light emitting module of the display module 120 may include multiple sub-light-emitting regions arranged in an array. Take the multiple sub-light-emitting regions of 10 columns and 6 rows shown in FIG. 5 as an example. The display module 120 may provide backlight through at least a part of the sub-light-emitting regions of the light emitting region 510 corresponding to the image region of the corrected image. In the embodiment, the control module 110 may set each row of the multiple sub-light-emitting regions in the light emitting region 510 that overlaps with the first sub-light-emitting region and the last sub-light-emitting region of an image boundary 520 of the corrected image as the multiple first sub-light-emitting regions.

As shown in FIG. 5, taking the first row of the light emitting region 510 as an example, the control module 110 may determine that the second sub-light-emitting region in the first row and the tenth sub-light-emitting region in the first row are the first sub-light-emitting region and the last sub-light-emitting region that overlap with the image boundary 520 of the corrected image in this row. Therefore, the control module 110 may record the information (that is, “2” and “10”) in a boundary information 530. By analogy, taking the sixth row of the light emitting region 510 as an example, the control module 110 may determine that the sixth sub-light-emitting region in the sixth row and the ninth sub-light-emitting region in the sixth row are the first sub-light-emitting region and the last sub-light-emitting region that overlap with the image boundary 520 of the corrected image in this row. Therefore, the control module 110 may record the information (that is, “6” and “9”) in the boundary information 530. The control module 110 may store the boundary information 530 through two registers.

Accordingly, the control module 110 may adjust light emitting data based on the boundary information 530 to increase brightness values corresponding to the sub-light-emitting regions recorded by the boundary information 530 and adjust brightness values of other sub-light-emitting regions outside the sub-light-emitting regions recorded by the boundary information 530 as 0.

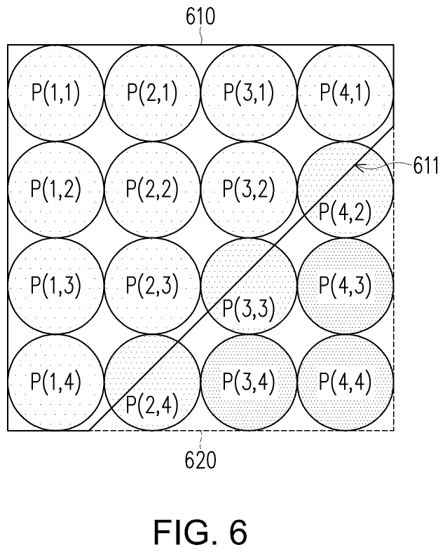

FIG. 6 is a driving diagram of a pixel array according to an embodiment of the disclosure. Referring to FIG. 1 and FIG. 6, the control module 110 may drive the display module 120 based on adjusted light emitting data. A part of a light emitting region 620 of a light emitting module of the display module 120 may include multiple light emitting units P(1, 1) to P(4, 4) shown in FIG. 6. Taking FIG. 6 as an example, an image boundary 611 of a corrected image 610 may, for example, overlap with multiple light emitting units P(2, 4), P(3, 3), and P(4, 2) of multiple sub-light-emitting regions of the display module 120. Furthermore, a non-display region outside the image boundary 611 may correspond to multiple light emitting units P(3, 4), P(4, 3), and P(4, 4). Therefore, the control module 110 may increase the brightness of the light emitting units P(2, 4), P(3, 3) and P(4, 2), and set brightness values of the light emitting units P(3, 4), P(4, 3), and P(4, 4) as 0.

In this regard, in an embodiment, the control module 110 may multiply brightness values corresponding to the light emitting units P(2, 4), P(3, 3), and P(4, 2) in light emitting data by a preset value to generate adjusted brightness values. The preset value is greater than 1. Furthermore, the control module 110 may adjust the light emitting data to allow the light emitting units P(3, 4), P(4, 3), P(4, 4) to emit no light (that is, turn off or not drive the light emitting units P(3, 4), P(4, 3) and P(4, 4)).

Therefore, since the brightness values of the light emitting units P(3, 4), P(4, 3), P(4, 4) corresponding to the non-display region are set as 0, the light emitting units P(3, 4), P(4, 3), P(4, 4) may not cause light leakage. Furthermore, since the brightness of the light emitting units P(2, 4), P(3, 3), and P(4, 2) located on the boundary of the display region is increased, the edge brightness of the image frame of the display region may be effectively compensated.

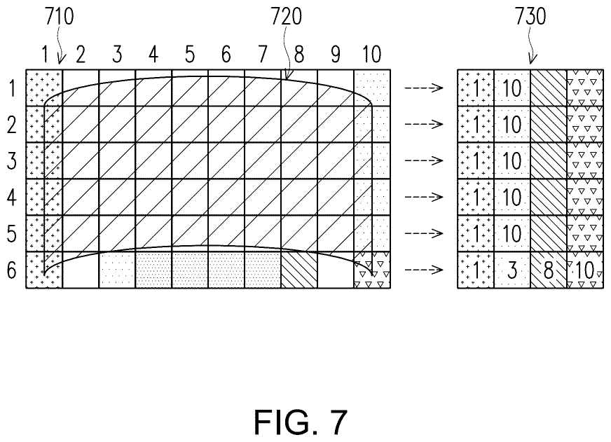

FIG. 7 is a schematic diagram of a corrected image according to another embodiment of the disclosure. Referring to FIG. 1 and FIG. 7, in an embodiment, a light emitting region 710 of a light emitting module of the display module 120 may include multiple sub-light-emitting regions arranged in an array. Take the multiple sub-light-emitting regions of 10 columns and 6 rows shown in FIG. 7 as an example. The display module 120 may provide backlight through at least a part of the sub-light-emitting regions of the light emitting region 710 corresponding to an image region of a corrected image. In the embodiment, the control module 110 may set each row of the multiple sub-light-emitting regions in the light emitting region 710 that continuously overlaps with each of the first sub-light-emitting regions and each of the last sub-light-emitting regions of multiple sections of an image boundary 720 of the corrected image as the multiple first sub-light-emitting regions.

As shown in FIG. 7, taking the first row of the light emitting region 710 as an example, the control module 110 may determine that the first sub-light-emitting region in the first row and the tenth sub-light-emitting region in the first row are the first sub-light-emitting region and the last sub-light-emitting region in this row that continuously overlap with the image boundary 720 of the corrected image. Therefore, the control module 110 may record the information (that is, “1” and “10”) in a boundary information 730. By analogy, taking the sixth row of the light emitting region 710 as an example, the control module 110 may determine that the first sub-light-emitting region in the sixth row and the third sub-light-emitting region in the sixth row are the first sub-light-emitting region and the last sub-light-emitting region in this row that continuously overlap with the image boundary 720 of the corrected image, and may also determine that the eighth sub-light-emitting region in the sixth row and the tenth sub-light-emitting region in the sixth row are another first sub-light-emitting region and another last sub-light-emitting region in this row that continuously overlap with the image boundary 720 of the corrected image. Therefore, the control module 110 may record the information (that is, “1”, “3”, “8” and “10”) in the boundary information 730. The control module 110 may store the boundary information 730 through four registers.

Accordingly, the control module 110 may adjust light emitting data based on the boundary information 730 to increase brightness values corresponding to sub-light-emitting regions recorded by the boundary information 730 and adjust brightness values of other sub-light-emitting regions outside the sub-light-emitting regions recorded by the boundary information 730 as 0.

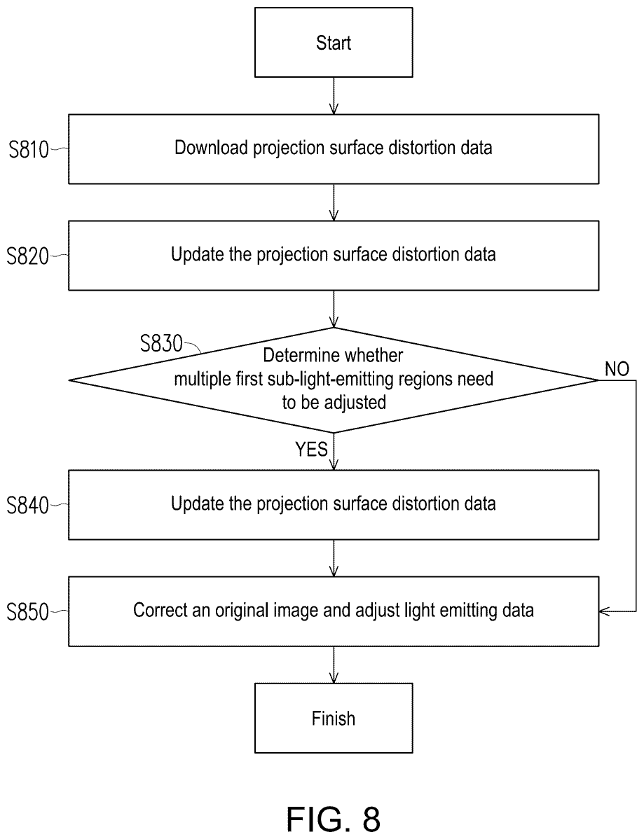

FIG. 8 is a flow chart of a display method of a head-up display according to another embodiment of the disclosure. Referring to FIG. 3 and FIG. 8, the head-up display 300 may perform the following steps S810 to S850. In step S810, the controller 310 may download projection surface distortion data. The controller 310 may, for example, read the projection surface distortion data from an external flash memory chip. In step S820, the controller 310 may update the projection surface distortion data stored in the storage device 313. In step S830, the controller 310 may determine whether multiple first sub-light-emitting regions need to be adjusted (that is, adjust regional position information of the sub-light-emitting regions that overlap with an image boundary of a corrected image). If yes, in step S840, the controller 310 may update the projection surface distortion data. If no or the update is completed, in step S850, the controller 310 corrects an original image and adjusts the light emitting data. Therefore, the head-up display 300 may effectively correct the image distortion displayed on the projection surface and improve the problem of light leakage.

In summary, the display method of the head-up display and the head-up display of the disclosure may automatically correct the image boundary of an image based on the distortion condition of the projection surface to improve the problem of image distortion. Furthermore, the display method of the head-up display and the head-up display of the disclosure may automatically increase the brightness of the boundary of a display region based on the image boundary of a distortion-corrected image, and set the brightness of a non-display region as 0. In this way, the problem of light leakage of a projection frame may be effectively improved.

Finally, it should be noted that the above embodiments are only used to illustrate the technical solution of the disclosure, but it is not to limit thereto. Although the disclosure has been described in detail with reference to the aforementioned embodiments, those skilled in the art should understand that the technical solutions described in the aforementioned embodiments may still be modified, or some or all of the technical features thereof may be replaced by equivalents; however, these modifications or substitutions do not make the essence of the corresponding technical solutions deviate from the scope of the technical solutions of the embodiments of the disclosure.

What is claimed is:

1. A display method for a head-up display, comprising:
receiving an original image;
correcting an image boundary of the original image based on projection surface distortion data to generate a corrected image;
determining a plurality of first sub-light-emitting regions corresponding to an image boundary of the corrected image;
adjusting light emitting data based on the image boundary of the corrected image to increase brightness values corresponding to the plurality of first sub-light-emitting regions in the light emitting data, and setting brightness values corresponding to a plurality of second sub-light-emitting regions of a non-display region in the light emitting data as 0; and
driving a display module based on the corrected image and an adjusted light emitting data.

2. The display method according to claim 1, wherein a shape of the image boundary of the original image is different from a shape of the image boundary of the corrected image.

3. The display method according to claim 1, wherein steps of determining the plurality of first sub-light-emitting regions corresponding to the image boundary of the corrected image comprise:
setting each row of a plurality of sub-light-emitting regions that overlaps with the first sub-light-emitting region and the last sub-light-emitting region of the image boundary of the corrected image as the plurality of first sub-light-emitting regions.

4. The display method according to claim 1, wherein steps of determining the plurality of first sub-light-emitting regions corresponding to the image boundary of the corrected image comprise:
setting each row of a plurality of sub-light-emitting regions that continuously overlaps with each of the first sub-light-emitting regions and each of the last sub-light-emitting regions of a plurality of sections of the image boundary of the corrected image as the plurality of first sub-light-emitting regions.

5. The display method according to claim 1, wherein steps of increasing the brightness values corresponding to the plurality of first sub-light-emitting regions in the light emitting data comprise:
multiplying the brightness values corresponding to the plurality of first sub-light-emitting regions by a preset value to generate adjusted brightness values,
wherein the preset value is greater than 1.

6. The display method according to claim 1, wherein steps of setting the brightness values of the plurality of second sub-light-emitting regions corresponding to the non-display region other than a plurality of sub-light-emitting regions in the light emitting data as 0 comprise:
allowing light emitting units of the plurality of second sub-light-emitting regions to emit no light.

7. The display method according to claim 1, further comprising:
downloading the projection surface distortion data;
updating the projection surface distortion data;
determining whether the plurality of first sub-light-emitting regions need to be adjusted;
updating the projection surface distortion data when the plurality of first sub-light-emitting regions need to be adjusted; and
correcting the original image and adjusting the light emitting data when the plurality of first sub-light-emitting regions do not need to be adjusted.

8. The display method according to claim 1, wherein steps of driving the display module comprise:
driving a display panel of the display module based on the corrected image; and
driving a light emitting module of the display module based on the adjusted light emitting data.

9. The display method according to claim 1, further comprising:
sensing a projection surface through a sensor to generate the projection surface distortion data.

10. The display method according to claim 1, wherein the head-up display comprises a self-light-emitting display panel.

11. A head-up display, comprising:
a display module; and
a control module, coupled to the display module,
wherein the control module determines a plurality of first sub-light-emitting regions corresponding to an image boundary of a corrected image, and adjusts light emitting data based on the image boundary of the corrected image to increase brightness values corresponding to the plurality of first sub-light-emitting regions in the light emitting data, and sets brightness values corresponding to a plurality of second sub-light-emitting regions of a non-display region in the light emitting data as 0,
wherein the control module drives the display module based on the corrected image and an adjusted light emitting data.

12. The head-up display according to claim 11, wherein the control module receives an original image and corrects an image boundary of the original image based on projection surface distortion data to generate the corrected image.

13. The head-up display according to claim 12, wherein a shape of the image boundary of the original image is different from a shape of the image boundary of the corrected image.

14. The head-up display according to claim 12, wherein the control module downloads the projection surface distortion data and updates the projection surface distortion data,
the control module determines whether the plurality of first sub-light-emitting regions need to be adjusted,
when the plurality of first sub-light-emitting regions need to be adjusted, the control module updates the projection surface distortion data; and
when the plurality of first sub-light-emitting regions do not need to be adjusted, the control module corrects the original image and adjusts the light emitting data.

15. The head-up display according to claim 11, wherein the control module sets each row of a plurality of sub-light-emitting regions that overlaps with the first sub-light-emitting region and the last sub-light-emitting region of the image boundary of the corrected image as the plurality of first sub-light-emitting regions.

16. The head-up display according to claim 11, wherein the control module sets each row of a plurality of sub-light-emitting regions that continuously overlaps with each of the first sub-light-emitting regions and each of the last sub-light-emitting regions of a plurality of sections of the image boundary of the corrected image as the plurality of first sub-light-emitting regions.

17. The head-up display according to claim 11, wherein the control module multiplies the brightness values corresponding to the plurality of first sub-light-emitting regions by a preset value to generate adjusted brightness values, wherein the preset value is greater than 1.

18. The head-up display according to claim 11, wherein the control module allows light emitting units of the plurality of second sub-light-emitting regions to emit no light.

19. The head-up display according to claim 11, wherein the control module drives a display panel of the display module based on the corrected image, and the control module drives a light emitting module of the display module based on the adjusted light emitting data.

20. The head-up display according to claim 11, further comprising:
a sensor, coupled to the control module and sensing a projection surface to generate the projection surface distortion data.
